(19) United States
(12) Patent Application Publication
(10) Pub. No.: US 2010/0179762 A1
(43) Pub. Date: Jul. 15, 2010

(54) Method of Correcting Imaging Data For Standoff and Borehole Rugosity

(75) Inventors: Leonty A. Tabarovsky, Cypress, TX (US); Michael S. Zhdanov, Salt Lake City, UT (US); Mikhail I. Epov, Novosibirsk (RU)

Correspondence Address: Mossman, Kumar and Tyler, PC, P.O. Box 421239, Houston, TX, 77242, US

(73) Assignee: Baker Hughes Incorporated, Houston, TX (US)

(21) Appl. No.: 12/351,979

(22) Filed: Jan. 12, 2009

(51) Int. Cl. G01V 3/18; G01V 3/00; G01V 3/38

(52) U.S. Cl. 702/7; 324/334; 324/338

(57) ABSTRACT

An apparatus having transmitter and receiver antennas is provided for measuring conductivity of an earth formation surrounding a borehole. The apparatus utilizes an initial model to invert induction measurements of the earth formation to provide a conductivity model that includes a plurality of coaxial cylinders.

### BACKGROUND OF THE DISCLOSURE

1. Field of the Disclosure

The present disclosure relates to well logging. In particular, the present disclosure is an apparatus and method for imaging of subsurface formations using electrical methods.

2. Background of the Art

Electrical earth borehole logging is well known and various devices and various techniques have been used for this purpose. Broadly speaking, there are two categories of devices that are typically used in electrical logging devices. The first category relates to galvanic devices wherein a source electrode is used in conjunction with a return electrode The second category relates to inductive measuring tools in which a loop antenna within the measuring instrument induces a current flow within the earth formation. The magnitude and/or phase of the magnetic field produced by the induced currents are detected using either the same antenna or a separate receiver antenna.

There are several modes of operation of a galvanic device. In one mode, the current at a current electrode is maintained constant and a voltage is measured between a pair of monitor electrodes. In another mode, the voltage of the measure electrode is fixed and the current flowing from the electrode is measured. If the current varies, the resistivity is proportional to the voltage. If the voltage varies, the resistivity is inversely proportional to the current. If both current and voltage vary, the resistivity is proportional to the ratio of the voltage to the current.

Generally speaking, galvanic devices work best when the borehole is filled with a conducting fluid. U.S. Pat. No. 7,250,768 to Ritter et al., having the same assignee as the present disclosure, which is fully incorporated herein by reference, teaches the use of galvanic, induction and propagation resistivity devices for borehole imaging in measurement-while-drilling (MWD) applications. Ritter discloses a shielded dipole antenna and a quadrupole antenna. In addition, the use of ground penetrating radar with an operating frequency of 500 MHz to 1 GHz is disclosed. One embodiment of the Ritter device involves an arrangement for maintaining the antenna at a specified offset from the borehole wall.

The prior art identified above does not address the issue of borehole rugosity and its effect on induction measurements. The problem of “seeing” into the earth formation is generally not addressed. In addition, usually the effect of mud resistivity on the measurements is not addressed. U.S. Pat. No. 7,299,131 to Tabarovsky et al., having the same assignee as the present disclosure, which is fully incorporated herein by reference, discloses an induction logging tool having transmitter and receiver antennas to make measurements of earth formations. The induction measurements are inverted using a linearized model. The model parameters are determined in part from caliper measurements. One embodiment of the method derived therein, while using a 3-D model, does not examine situations of layered-cylindrical models of the earth's resistivity. The present disclosure addresses the layered-cylindrical models of the earth resistivity.

### SUMMARY OF THE DISCLOSURE

One embodiment of the present disclosure is an apparatus for estimating a conductivity of an earth formation. The apparatus may include: at least one transmitter antenna and at least one receiver coil disposed on a tool configured to be conveyed in a borehole in the earth formation, the at least one receiver configured to produce measurements indicative of the conductivity of the earth formation in response to activation of the at least one transmitter antenna. The apparatus also may include at least one processor that is configured to use an initial model to invert the measurements to provide a conductivity model of the formation that includes a plurality of coaxial cylinders.

Another embodiment is a method of estimating a conductivity of an earth formation. The method may include: using at least one transmitter antenna on a logging tool conveyed in a borehole to induce an electromagnetic field in the earth formation; using at least one receiver coil disposed on the tool to produce measurements indicative of a conductivity of the earth formation in response to activation of the at least one transmitter antenna, and using an initial model to invert the measurements to provide a conductivity model of the formation that comprises a plurality of coaxial cylinders.

Another embodiment is a computer-readable-medium accessible to at least one processor, the computer-readable medium comprising instructions that enable the at least one processor to use an initial model to invert measurements indicative of a conductivity of the earth formation made by an apparatus including at least one transmitter antenna and at least one receiver antenna to provide a conductivity model of the formation that comprises a plurality of coaxial cylinders.

### BRIEF DESCRIPTION OF THE FIGURES

The novel features that are believed to be characteristic of the disclosure will be better understood from the following detailed description in conjunction with the following drawings, in which like elements are generally given like numerals and wherein:

FIG. 1 is a schematic illustration of a drilling system;

FIG. 2 illustrates one embodiment of the present disclosure on a drill collar;

FIG. 3 is a cross-sectional view of a logging tool including a transmitter and a receiver in a borehole;

FIG. 4 shows the plane layer approximation used in one embodiment of the disclosure;

FIG. 5 shows a sectional view of variations in borehole size;

FIG. 6 illustrates an arrangement of loop antennas;

FIG. 7 shows an exemplary model used for evaluating the method of the present disclosure;

FIG. 8 shows a background model corresponding to the model of FIG. 7;

FIGS. 9A and 9B show responses of the antennas of FIG. 6 to the model of FIG. 7;

FIG. 10 shows results after one and four iterations of using the method of the present disclosure on the responses shown in FIGS. 9A and 9B;

FIG. 11 shows an exemplary 3-D model used for evaluating the method of the present disclosure;

FIG. 12 shows a background model corresponding to the model of FIG. 11;

FIGS. 13A and 13B show responses of the antennas of FIG. 6 to the model of FIG. 11;

FIGS. 14A and 14B show results after one and four iterations of using the method of the present disclosure on the responses shown in FIGS. 13A and 13B;

FIG. 15 shows the geometry of a model having concentric cylinders; and

FIG. 16 is a flow chart illustrating the method of one embodiment of the disclosure.

### DETAILED DESCRIPTION OF THE DISCLOSURE

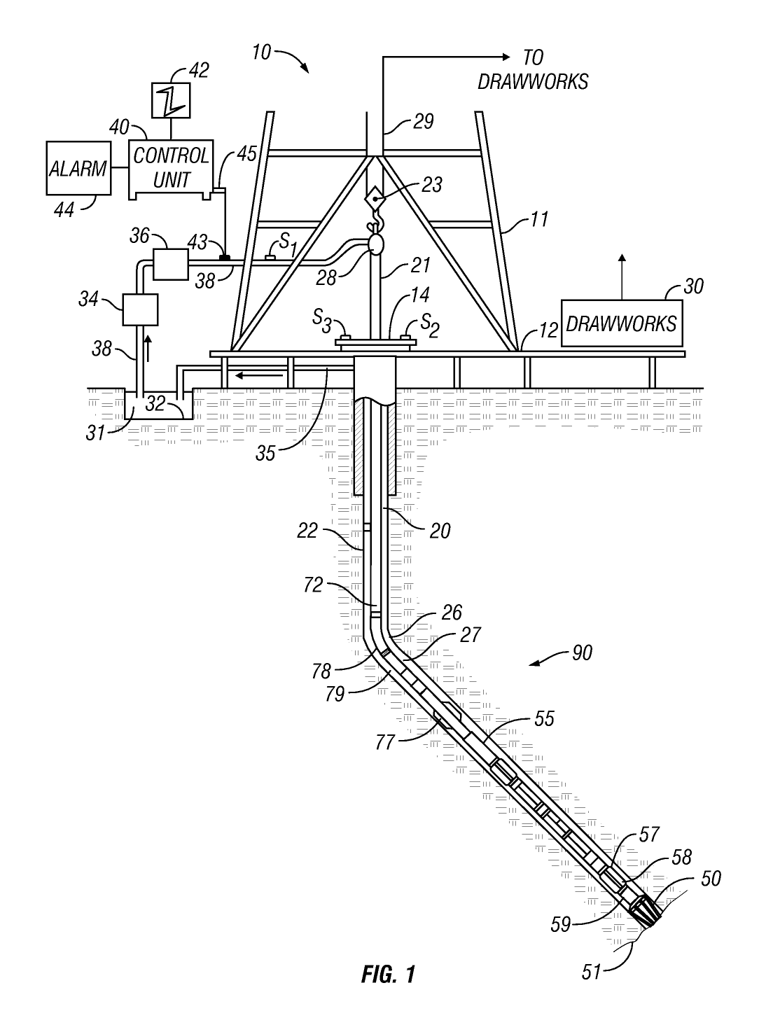

FIG. 1 shows a schematic diagram of a drilling system 10 with a drillstring 20 carrying a drilling assembly 90 (also referred to as the bottomhole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), into the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel, 28 and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger, fluid line 38 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ placed in the line 38 may provide information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the disclosure, the drill bit 50 is rotated by only rotating the drill pipe 22. In another embodiment of the disclosure, a downhole motor 55 (mud motor) is disposed in the drilling assembly 90 to rotate the drill bit 50. The drill pipe 22 is rotated to supplement the rotational power, if required, and to effect changes in the drilling direction.

In the embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90. The drilling assembly includes a controller 80 that may further include a processor, one or more data storage device and computer programs accessible to the processor for controlling the operation of the drilling assembly and to perform the functions described herein. The controller 80 may use the induction measurement to provide conductivity of the earth formations as described in more detail later or send.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 typically includes a computer or a microprocessor-based processing system, memory for storing programs or models and data, a recorder for recording data, and other peripherals. The control unit 40 is typically adapted to activate alarms 44 when certain unsafe or undesirable operating conditions occur. The control unit 40 also may receive data from the drilling assembly and process such data according to programmed instructions stored in the control unit to provide the conductivity of the earth formations according to the methods described herein. The drilling system includes a novel resistivity sensor described below.

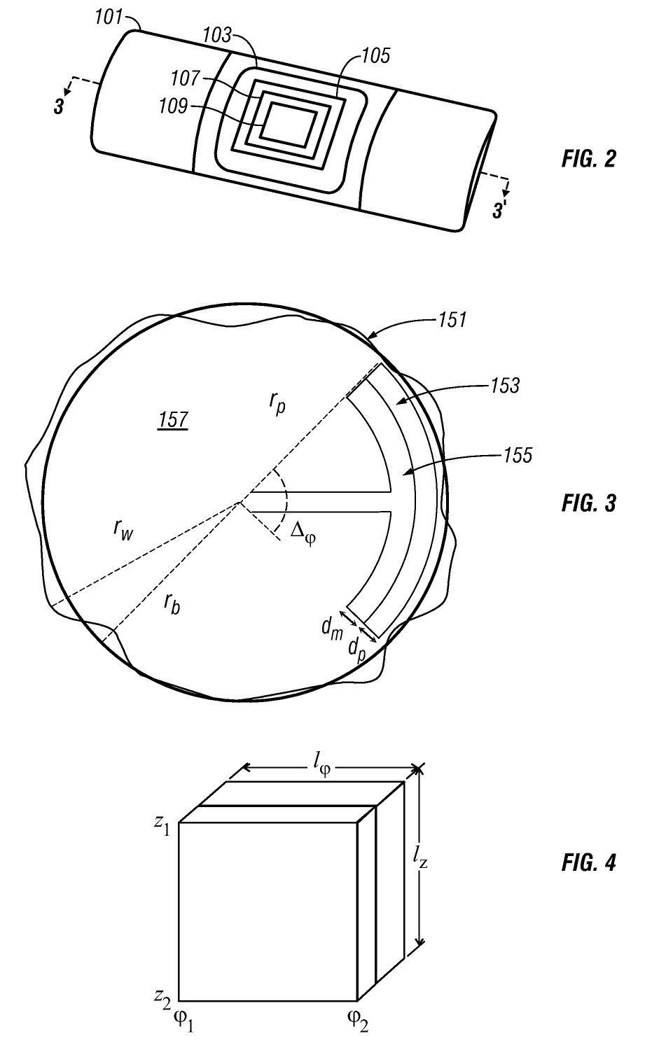

Turning now to FIG. 2, one configuration of a resistivity sensor for MWD applications is shown. Shown is a section of a drill collar 101 with a recessed portion 103. The drill collar forms part of the bottomhole assembly (BHA) discussed above for drilling a wellbore. For the purposes of this document, the BHA may also be referred to a downhole assembly. Within the recessed portion, there is a transmitter antenna 109 and two receiver antennas 105, 107 (the far receiver or receiver R2, and the near receiver or receiver R1) that are substantially concentric with the transmitter antenna. It is to be noted that the term “concentric” has two dictionary definitions. One is “having a common center”, and the other is “having a common axis.” The term concentric as used herein is intended to cover both meanings of the term. As can be seen, the axis of the transmitter antenna and the receiver antenna is substantially orthogonal to the longitudinal axis of the tool (and the borehole in which it is conveyed). Based on simulation results (not shown) it has been found that having the transmitter antenna with an axis parallel to the borehole (and tool) axis does not give adequate resolution.

Operation of an induction logging tool such as that disclosed in FIG. 2 is discussed next in the context of an exemplary borehole filled with oil-base mud. Borehole walls are irregular. Resistivities behind the borehole wall need be determined as a function of both the azimuthal angle and depth. An array for determination of resistivities may be mounted above a sidewall pad. The generic schematic representation of a medium and a pad is shown in FIG. 3.

Shown in FIG. 3 is a borehole 157 having mud therein and a wall 151. As can be seen, the wall is irregular due to rugosity. A metal portion of an antenna on a resistivity measuring tool is denoted by 155 and an insulating portion by 153.

A polar coordinate system {r, φ, z} is indicated in FIG. 3. The vertical z axis is in line with the borehole axis and it is directed downward (i.e., into the paper). The borehole radius is considered to be a function of both the azimuthal angle and depth

r_{w}=f(φ,z) (1)

The nominal borehole radius is designated as r_{d}. Further it is assumed that mean deviations of real value of distance to the borehole wall from a nominal radius within the depth range (z₁, z₂) are relatively insignificant

$${δ}_{r} = \frac{{\int }_{{z}_{1}}^{{z}_{2}} {\int }_{0}^{2 π} \vert {r}_{w} - {r}_{d} \vert r d r d ϕ}{π {r}_{d}^{2}} \leq 0.1 . \qquad ( 2 )$$

The surface of the insulating area of a sidewall pad is described by equation

rₚ=f(φ₁,φ₂,z₁,z₂,φ,z)=c₁, z₁≦z≦z₂. (3)

The surface of the metallic part of a pad is described by equation

rₘ=f(φ₁,φ₂,z₁,z₂,φ,z)=c₁, z₁≦z≦z₂. (4)

Here Δφ=(φ₂−φ₁) and (z₂−z₁) are both angular and vertical sizes of a pad, dₚ=rₚ−rₘ is the insulator thickness, dₘ is the metal thickness.

Contact of the pad with the borehole wall implies that in the domain [φ₁, φ₂, z₁, z₂] there exist points at which rₚ=r_{w}. For the remaining points, the following inequality is obeyed rₚ<r_{w}. As an example, the angular size of a sidewall pad is taken to be 45°. Referring to FIG. 4, the pad dimensions are l_{φ} and l_{z} at the nominal borehole diameter r_{b}. For the examples given below, r_{b} is 0.108 m and l_{φ} and l_{z} are taken to be 0.085 m.

In the model, the oil-base mud resistivity is equal to 10³ Ω-m, the resistivity of the insulating area on the pad surface is 10³ Ω-m, and the metallic case resistivity of a pad is in the order of 10⁻⁶ Ω-m. The rock resistivity varies in the range 0.1-200 Ω-m. We consider the radial thickness of the insulating pad area is equal to dₚ=0.02 m, the radial thickness of the metallic pad area is equal to dₘ=0.03 m.

To simplify the analysis, instead of the model with concentric boundaries shown in FIG. 3, we take the planar-layered model of FIG. 4. The relative deviation of the pad surface from the plane is given by

$$Δ {r}_{p} / {r}_{p} \approx 1 - cos \frac{π}{8} = 0.076 .$$

The linear pad size in the plane z=\tilde{z}(z₁≦\tilde{z}≦z₂) is equal to

$${\tilde{l}}_{ϕ} = 2 {r}_{p} sin \frac{π}{8} = 0.083 .$$

The relative change in linear size

$$δ l = \frac{{l}_{ϕ} - {\tilde{l}}_{ϕ}}{{l}_{ϕ}}$$

is less than 2.5%.

The skin depth in the metallic pad area

$$δ \approx \frac{0.005}{\sqrt{f}}$$

(f is the frequency in MHz). At the frequency f=1 MHz, the skin depth is 5 mm. It is essentially less than the radial depth dₘ. Hence, the results of calculations may be considered as slightly affected by this value.

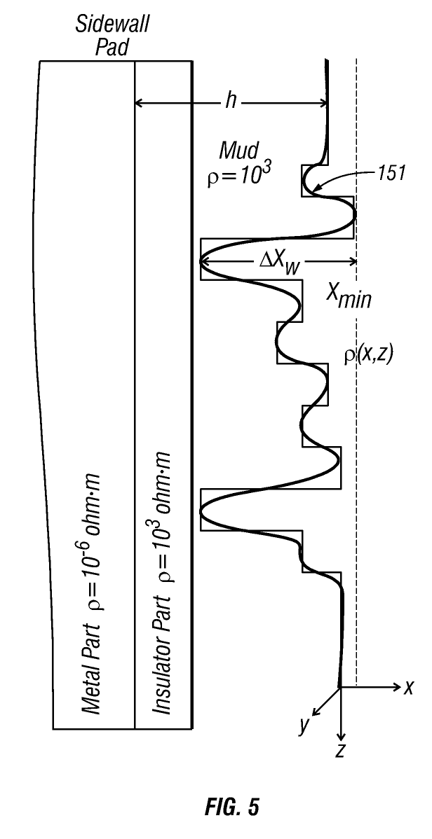

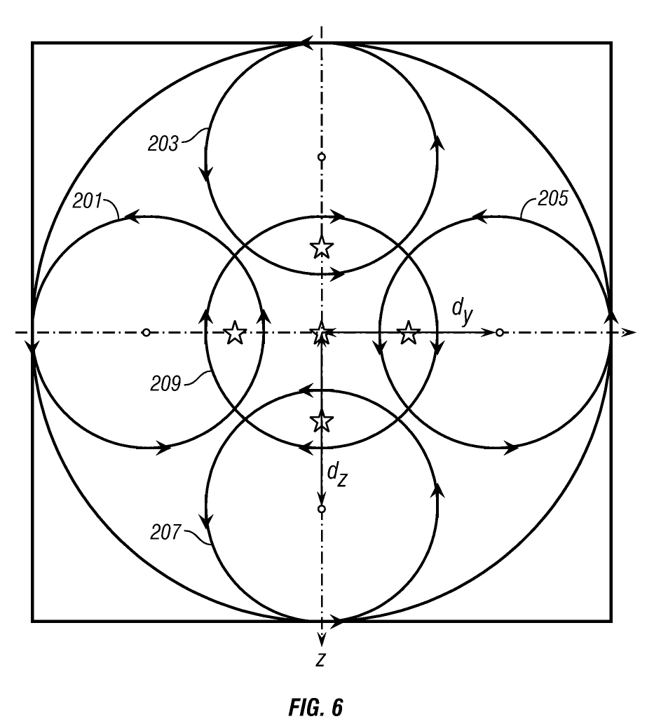

The three-layer model in the plane approximation is characterized by Cartesian coordinates {x, y, z}. The x axis is perpendicular to the pad surface and it is directed to the right in FIG. 5. Then the pad surface is described by equation x=0. This surface divides highly conductive half-space (the metallic pad part) and non-conducting area. The latter includes the non-conducting pad part and mud layer. The layer thickness is variable due to the borehole wall irregularity. The “Mud—medium” boundary equation can be written in the following form

i x_{w}=f(y,z). (5)

At that x_{w}≧0, an amplitude of boundary relief can be determined as follows:

Δx_{w}=x_{w}−xₘᵢₙ, (6)

where xₘᵢₙ=min{x_{w}} for all (y, z). The amplitude of an irregular boundary Δx_{w} is 0.01 m on average. Beyond this boundary, an inhomogeneous conducting medium is located. The complete model is shown in FIG. 5 where 151 is the borehole wall. The three layers of the model comprise (i) the metal, (ii) the insulator and borehole fluid, and (iii) the formation outside the borehole wall.

As a source of a field, current loops are chosen that are located in parallel with the wall contact equipment surface and are coated with insulator with thickness less than 0.01 m. Receiving loops are also mounted here. For the purposes of the present disclosure, the terms “loop” and “coil” may be used interchangeably. Two arrays are placed above a sidewall pad. The first array consists of two coaxial current loops of relatively large size (radius is 0.5 l_{φ}). The loops are spaced apart from each other at a distance of 0.01 m the direction perpendicular to the pad surface. The small loop that is coaxial with the transmitter loops is located in the midst. The ratio between loop currents is matched so that a signal is less than the noise level in the absence of a medium under investigation. The frequency of supply current is chosen so that a skin depth would be larger of characteristic sizes of inhomogeneities.

To investigate medium structure, an array comprising a set of current loops has been simulated. The placing of loops 201, 203, 205, 207, 209 as well as directions of currents are shown in FIG. 6. Measurements points and the current direction are chosen in such a way to suppress the direct loop field. The measurements points are denoted by the star symbols in FIG. 6. Distances between centers of current loops are designated as d. If the loop centers are spaced along the z axis, d=d_{z}, and if the loop centers are spaced along the y axis, d=d_{y}. A measurement point is always located at the same distance from loop centers. Actually current and receiving loops would be situated in different planes. However, to simplify calculations, these loops are located in the same plane.

A mathematical statement of the forward modeling program follows. A horizontal current turn of radius r₀ with the center at the point (x₀, y₀, z₀) is represented by an exterior inductive source. Hereinafter x₀=0. A monochromatic current flows in the turn, the current density being

\vec{j}^{cm}=I₀δ(x−x₀)δ(y−y₀)δ(z−z₀)e^{-iωt}, (7)

here ω=2πf is the angular frequency, δ is the Dirac delta function, and I₀ is the current amplitude.

The electric field \vec{E}(x, y, z). Maxwell equations in a conductive nonmagnetic medium (μ=μ₀=4π·10⁻⁷ H/m) has the form

$$\{ \begin{matrix}∇ \times {H}^{->} = \tilde{σ} {E}^{->} + {{j}^{->}}^{c m} \\ ∇ \times {E}^{->} = i ω {μ}_{0} {H}^{->}\end{matrix} \qquad ( 8 )$$

where \vec{j}^{cm}={jₓ^{cm},j_{y}^{cm},j_{z}^{cm}} and \tilde{σ}=(σ−iωε) is the complex conductivity, σ is the conductivity, ε is the permittivity. From the system of equations (8), Helmholtz's equation for an electric field \vec{E} in the domain containing a source gives

∇×∇×\vec{E}+k²(ξ)\tilde{E}=−iωμ₀\vec{j}^{cm} (9)

here ξ (x, y, z) is the observation point, k=\sqrt{−iωμ₀\tilde{σ}} is the wave number.
At all boundaries, tangential electric field components are continuous

[E_{τ}]ₓ₌ₓ_{ⱼ}=0, (10)

the condition of descent at infinity is met

$$\vert {E}_{x , y , z} \vert {\to }_{ξ -> ∞} 0 \qquad ( 11 )$$

Equation (9) in conjunction with conditions (10)-(11) defines the boundary problem for the electric field.

An approximate solution of a boundary problem is derived next by a perturbation technique. It is assumed that the three-dimensional conductivity distribution can be represented as a sum

σ(ξ)=σ^{b}(z)+δσ(ξ), (12)

where σ^{b}(z) is the one-dimensional conductivity distribution that depends only on the z coordinate, δσ(ξ) are its relatively minor three-dimensional distributions. The values of perturbations are determined by the following inequality:

$$\frac{max \vert δ σ ( ξ ) \vert}{{σ}^{b} ( z )} < 0.2 .$$

The model with one-dimensional conductivity distribution σ^{b}(z) will be hereinafter termed as background model and corresponding field as normal fields. Starting from eqn. (12), an electric field can be described as a sum of background and perturbed components

\vec{E}=\vec{E}^{b}+δ\vec{E}, (13)

where \vec{E}^{b} is the background electric field and δ\vec{E} is its perturbation. The \vec{E}^{b} field obeys the following equation

∇×∇×\vec{E}^{b}+[k^{b}(z)]²\vec{E}^{b}=−iωμ₀\vec{j}^{cm}, (14)

here k^{b}(z)=\sqrt{−iωμ₀σ^{b}(z)} is wave number for the background model. Substituting eqns. (12)-(13) into eqn. (14), we obtain

∇×∇×(\vec{E}^{b}+δ\vec{E})+([k^{b}(z)]²+δk²(ξ))(\vec{E}^{b}+δ\vec{E})=−iωμ₀\vec{j}^{cm}, (15)

where δk²(ξ) is perturbation of the wave number square associated with relatively minor spatial variations of conductivity in some domain V.

From (14) and (15), we obtain equation for the perturbed component δ\vec{E}

∇×∇×δ\vec{E}+[k^{b}(z)]²δ\vec{E}=−δk²(ξ)(\vec{E}^{b}+δ\vec{E}) (16)

Vector eqn. (16) can be solved using the Green's functions. These functions are solutions of the same equation, but with other right part

∇×∇×\vec{G}^{E}+[k^{b}(z)]²\vec{G}^{E}=δ(x−x₀)δ(y−y₀)δ(z−z₀)i_{x,y,z}, (17)

here \vec{i}ₓ,\vec{i}_{y},\vec{i}_{z}, are unit vectors of the generic Cartesian coordinates.

Then from eqns, (16) and (17), we obtain

$$δ \vec{E} = - {\int }_{V} δ {k}^{2} ( ξ ) {\vec{G}}^{E} ( {{E}^{->}}^{b} + δ \vec{E} ) d V . \qquad ( 18 )$$

We now consider a model in which the perturbation is a change of conductivity.

If the source loop and measurement point are situated outside of the conductivity perturbation domain, then the electric field \vec{E}(ξ₀|ξ) is the solution of integral Fredholm's equation

$$\vec{E} ( {ξ}_{0} \vert ξ ) = {\vec{E}}^{b} ( {ξ}_{0} \vert ξ ) - {\int }_{V} δ {k}^{2} ( {ξ}^{′} ) {\vec{G}}^{E} ( ξ \vert {ξ}^{′} ) \vec{E} ( {ξ}_{0} \vert {ξ}^{′} ) d V . \qquad ( 19 )$$

here ξ₀(x₀, y₀, z₀), ξ(x, y, z) are points defining the position of both a source and receiver and ξ′(x′, y′, z′) is the integration point. From initial equations, both a magnetic field and corresponding Green's vector are determined by the given electric field.

$$\vec{H} = \frac{1}{{iωμ}_{0}} ∇ \times \vec{E} , {\vec{G}}^{H} = \frac{1}{{iωμ}_{0}} ∇ \times {\vec{G}}^{E} . \qquad ( 20 ) .$$

As known, the magnetic field \vec{H}(ξ₀|ξ) can be determined from a similar (19) integral equation

$$\vec{H} ( {ξ}_{0} \vert ξ ) = {\vec{H}}^{b} ( {ξ}_{0} \vert ξ ) - {\int }_{V} δ {k}^{2} ( {ξ}^{′} ) {\vec{G}}^{H} ( ξ \vert {ξ}^{′} ) \vec{H} ( {ξ}_{0} \vert {ξ}^{′} ) d V . \qquad ( 21 )$$

When fields are determined, a linear approximation consists in substitution of full fields in integrands (20) and (21) by fields in a background medium

\vec{E}(ξ)≈\vec{E}^{b}(ξ), \vec{H}(ξ)≈\vec{H}^{b}(ξ) (22)

Thus the azimuthal electric and the horizontal magnetic field components are described by integrals:

$${E}_{ϕ} ( {ξ}_{0} \vert ξ ) = {E}_{ϕ}^{b} ( {ξ}_{0} \vert ξ ) - {\int }_{V} δ {k}^{2} ( {ξ}^{′} ) {E}_{ϕ}^{b} ( ξ \vert {ξ}^{′} ) {E}_{ϕ}^{b} ( {ξ}_{0} \vert {ξ}^{′} ) d V , \\ {H}_{x} ( {ξ}_{0} \vert ξ ) = {H}_{x}^{b} ( {ξ}_{0} \vert ξ ) - {\int }_{V} δ {k}^{2} ( {ξ}^{′} ) {H}_{z}^{b} ( ξ \vert {ξ}^{′} ) {H}_{z}^{b} ( {ξ}_{0} \vert {ξ}^{′} ) d V . \qquad ( 23 )$$

Accuracy of a linear approximation depends on a choice of background model, sizes of inhomogeneity, and relatively contrasting electrical conductivity. As a background model, we use three-layer planar-layered model described above with reference to FIG. 5. We introduce the cylindrical coordinate system {r, φ, x}, where

$$r = \sqrt{{y}^{2} + {z}^{2}} , tan ϕ = \frac{y}{z} .$$

Thus when both the source and receiver are located in a layer, the horizontal magnetic field component is described by the expression:

$${H}_{x} = {H}_{x}^{0} + {Ir}_{0} {\int }_{0}^{∞} {λ}^{2} {J}_{1} ( λ {r}_{0} ) {J}_{0} ( λ r ) {Φ}_{2}^{2} d λ . \\ Here \\ h = {x}_{2} - {x}_{1} , \\ {Φ}_{2}^{2} = - \frac{1}{2 {p}_{2} Δ} [ ( {e}^{- {p}_{2} ( {x}_{2} - x )} - {k}_{12} {e}^{- {p}_{2} h} {e}^{- {p}_{2} ( x - {x}_{1} )} ) {k}_{32} {e}^{- {p}_{2} ( {x}_{2} - {x}_{0} )} ++ ( {e}^{- {p}_{2} ( x - {x}_{1} )} - {k}_{32} {e}^{- {p}_{2} h} {e}^{- {p}_{2} ( {x}_{2} - x )} ) {k}_{12} {e}^{- {p}_{2} ( {x}_{0} - {x}_{1} )} ] , \\ I = {I}_{0} {e}^{- iω t} , {k}_{j}^{2} = - {iωμ}_{0} {σ}_{j} - {ω}^{2} {μ}_{0} {ɛ}_{j} , {p}_{j} = \sqrt{{k}_{j}^{2} + {λ}^{2}} j = 1 , … , 3 \\ ( j = 1 - metal pad part , j = 2 - insulator pad part , j = 3 - investigated medium ) , \\ {k}_{12} = \frac{{p}_{1} - {p}_{2}}{{p}_{1} + {p}_{2}} , {k}_{32} = \frac{{p}_{3} - {p}_{2}}{{p}_{3} + {p}_{2}} , Δ = 1 - {k}_{12} {k}_{32} {e}^{- 2 {p}_{2} h} . \qquad ( 24 )$$

Here the horizontal magnetic component of the field generated by a current loop of the radius r₀ in a homogenous medium with formation parameters is

$${H}_{x}^{0} = - \frac{{Ir}_{0}}{π} {\int }_{0}^{∞} {pI}_{1} ( {pr}_{0} ) {K}_{0} ( pr ) cos ( λ \vert x - {x}_{0} \vert ) d λ , r \geq {r}_{0} , \\ {H}_{x}^{0} = \frac{{Ir}_{0}}{π} {\int }_{0}^{∞} {pI}_{0} ( pr ) {K}_{1} ( {pr}_{0} ) cos ( λ \vert x - {x}_{0} \vert ) d λ , r \leq {r}_{0} . \qquad ( 25 )$$

Let us consider an integral over the conductivity perturbation domain from (24) and (25) as a superposition of secondary source fields. We determine an integrand similarly to expression (24) and (25). The integrand is described in the multiplicative form. The anomalous part of the horizontal magnetic field component of a current loop can be represented as a superposition of responses from corresponding horizontal and vertical electric dipoles. In this case, the responses are Green's functions and these define moments of secondary sources δk²(ξ′)E_{xz} and δk²(ξ′)E_{xy}. The cofactors (E_{xz}, E_{xy}) can be defined as follows

$${E}_{xz} = - {iωμ}_{0} {I}_{{r}_{0}} sin {χ}_{1} {\int }_{0}^{∞} λ {J}_{1} ( λ {r}_{0} ) {J}_{1} ( λ {r}_{1} ) {Φ}_{3}^{2} d λ , \\ {E}_{xy} = {iωμ}_{0} {Ir}_{0} cos {χ}_{1} {\int }_{0}^{∞} λ {J}_{1} ( λ {r}_{0} ) {J}_{1} ( λ {r}_{1} ) {Φ}_{3}^{2} d λ$$

$$or$$

$${E}_{xz} = sin {χ}_{1} {E}_{ϕ} , {E}_{xy} = - cos {χ}_{1} {E}_{ϕ} , \\ {E}_{ϕ} = - {iωμ}_{0} {Ir}_{0} {\int }_{0}^{∞} λ {J}_{1} ( λ {r}_{0} ) {J}_{1} ( λ {r}_{1} ) {Φ}_{3}^{2} d λ . \\ Where$$

$${Φ}_{3}^{2} = \frac{1}{( {p}_{3} + {p}_{2} ) Δ} [ ( {e}^{- {p}_{2} ( {x}_{2} - {x}_{0} )} - {k}_{12} {e}^{- {p}_{2} h} {e}^{- {p}_{2} ( {x}_{0} - {x}_{1} )} ) {e}^{- {p}_{3} ( {x}^{′} - {x}_{2} )} ] , \\ {r}_{1} = \sqrt{{( {z}_{0} - {z}^{′} )}^{2} + {( {y}_{0} - {y}^{′} )}^{2}} .$$

Correspondingly, vertical magnetic field components (H_{zx}, H_{xy}) from secondary sources are represented in the form

$${H}_{zx} = sin {χ}_{2} {\int }_{0}^{∞} {λ}^{2} {J}_{1} ( λ {r}_{2} ) {Φ}_{2}^{3} d λ$$

$${H}_{xy} = - cos {χ}_{2} {\int }_{0}^{∞} {λ}^{2} {J}_{1} ( λ {r}_{2} ) {Φ}_{2}^{3} d λ$$

$$or$$

$${H}_{zx} = sin {χ}_{2} {H}_{x} , {H}_{xy} = - cos {χ}_{2} {H}_{x} , {H}_{x} = \frac{1}{2 π} {\int }_{0}^{∞} {λ}^{2} {J}_{1} ( λ {r}_{2} ) {Φ}_{2}^{3} d λ , \\ where$$

$${Φ}_{2}^{3} = \frac{1}{( {p}_{3} + {p}_{2} ) Δ} [ ( {e}^{- {p}_{2} ( {x}_{2} - x )} - {k}_{12} {e}^{- {p}_{2} h} {e}^{- {p}_{2} ( x - {x}_{1} )} ) {e}^{- {p}_{3} ( {x}^{′} - {x}_{2} )} ] , \\ {r}_{2} = \sqrt{{( z - {z}^{′} )}^{2} + {( y - {y}^{′} )}^{2}}$$

$$cos {χ}_{1} = \frac{{z}_{0} - {z}^{′}}{{r}_{1}} , sin {χ}_{1} = \frac{{y}_{0} - {y}^{′}}{{r}_{1}} , \\ cos {χ}_{2} = \frac{z - {z}^{′}}{{r}_{2}} , sin {χ}_{2} = \frac{y - {y}^{′}}{{r}_{2}} .$$

The current loop with center in point ξ₀ and observation point ξ ape located in a layer and the secondary source and current integration point ξ′ is located in the lower half-space.

The resultant expression of the integrand takes form

E_{xz}H_{xy}+E_{xy}H_{yx}=E_{φ}Hₓ cos(χ₂−χ₁).

Thus, the horizontal magnetic field component is described by the following integral expression

$${H}_{x} ( {ξ}_{0} \vert ξ ) = {H}_{x}^{0} ( {ξ}_{0} \vert ξ ) + {\int }_{V} δ {k}^{2} ( {ξ}^{′} ) {E}_{ϕ} ( {ξ}_{0} \vert {ξ}^{′} ) {H}_{x} ( ξ \vert {ξ}^{′} ) cos ( {χ}_{2} - {χ}_{1} ) d V . \qquad ( 25 a )$$

We next discuss the inversion problem of determining a resistivity distribution corresponding to measured signals. From eqn. 25(a), the e.m.f. difference between initial and background models δe can be approximately described in the form of a linear system of algebraic equations

\vec{δ}e≈A \vec{δ}σ, (26)

here \vec{δ}e is a set of increments of measured values, \vec{δ}σ is a set of conductivity perturbations, A is the rectangular matrix of linear coefficients corresponding to integrals over perturbation domains. The matrix A is a Jacobian matrix of partial derivatives of measured values relative to perturbations of the background model. This is determined from the right hand side of eqn. (25a) using known methods. The dimensionality of the matrix is N_{F}×N_{P} (N_{F} is the number of measurements, N_{P} is the number of partitions in the perturbation domain).

Solution of the inverse problem is then reduced to a minimization of the objective function (difference between field and synthetic logs)

$$F = \frac{1}{{N}_{F}} \sqrt{{\sum }_{i = 1}^{{N}_{F}} {( \frac{{e}_{i}^{E} - {e}_{i}^{T}}{{e}_{i}^{E}} )}^{2}}$$

where eᵢ^{E} and eᵢ^{T} are observed and synthetic values of a difference e.m.f., respectively. Elements of vectors \vec{δ}e and \vec{δ}σ of the linear system of algebraic equations are defined as

δeᵢ=eᵢ^{E}−eᵢ^{T}, δσⱼ=σ^{b}−σⱼ,

here indices i=1, . . . ,N_{F} and j=1, . . . ,N_{P} are numbers of measurements and values of electrical conductivity in j-domain, respectively.

Let us linearize the inverse problem in the vicinity of model parameters. The functional minimum F is attained if

\vec{δ}σ≈A⁻¹ \vec{δ}e,

here A⁻¹ is a sensitivity matrix,

$${a}_{ij} = \frac{\partial {e}_{ij}^{b}}{\partial {σ}_{ij}^{b}}$$

are elements of the matrix.

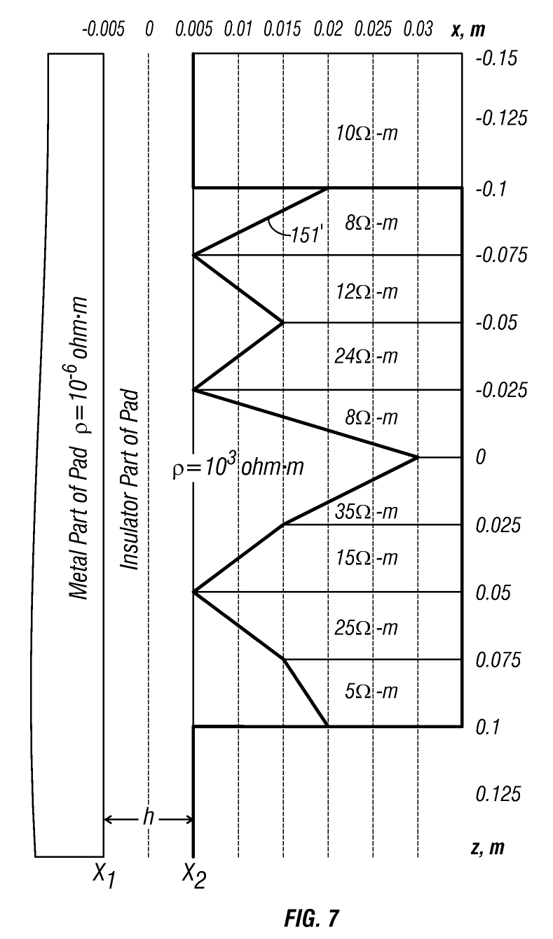

We consider several examples of reconstruction of the electrical resistivity distribution in a medium. Shown in FIG. 7 is a two-dimensional relief of the borehole wall. The relief is assumed to change within the range of length 0.2 m (from −0.1 m to 0.1 m). Its maximum amplitude is 0.025 m. The operating frequency is equal to 20 MHz.

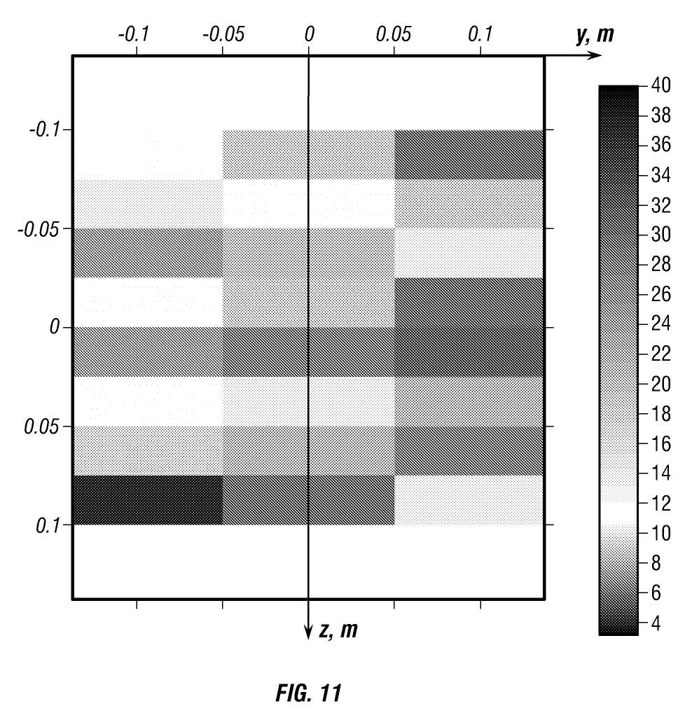

Two models are considered. The first model is two dimensional (resistivity is invariant along the y axis). The resistivity distribution along the borehole wall is shown in FIG. 7. The resistivities are as indicated and the borehole wall is given by 151′. The second model is three-dimensional. The resistivity distribution in the planes y=±0.025 is shown in FIG. 11. At y=0, the resistivity distribution is the same as for the two-dimensional model (FIG. 7). The background model resistivity is equal to 10 ohm·m. Resistivities of subdomains range from 5 to 35 ohm·m. The width of all subdomains is the same and it is 0.025 or 0.05 m.

When averaged resistivity are determined, the array of the type shown in FIG. 2 is used. Currents in generator loops are given proportionally to the ratio of normal e.m.f.

$$\frac{{I}_{2}}{{I}_{1}} = - \frac{Re {e}_{1}}{Re {e}_{2}} = - \frac{0.419}{0.482} = - 0.868 .$$

A signal measured in such a system is mostly dependent on the average resistivity of a medium being investigated.

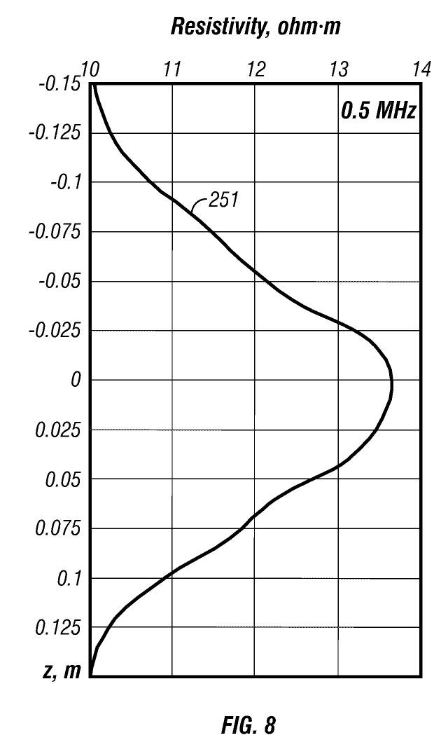

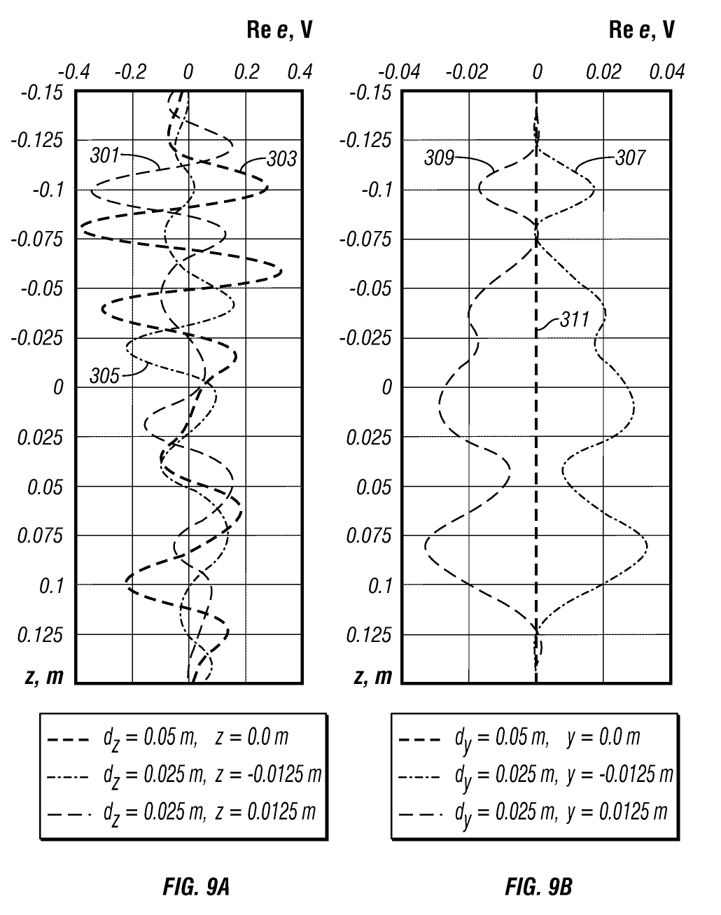

In FIG. 8, there is shown the resistivity distribution 251 in a background medium obtained through measurements by an array of the type shown in FIG. 2. In FIG. 9A, there are shown synthetic logs 301, 303, 305 for three arrays d_{z}=2r₀=0.05 m and d_{z}=±r₀=±0.025 m. The array centers are located along the z axes. See FIG. 6. The arrays can move along the z axis. The normal signal (in “a metal—insulator” medium) for a separate ring e₀≈6 V. At the compensation coefficient 10⁻³, effect of metallic pad part will be less than 6 mV. In this case, a useful signal attains the value of 400 mV.

In FIG. 9B are shown synthetic logs 307, 309, 311 for the same arrays, but the array centers are located along the y axis. The arrays can move along the z axis. In this case, a useful signal is about 2-3 times less that than in previous case and it does not exceed 150 mV.

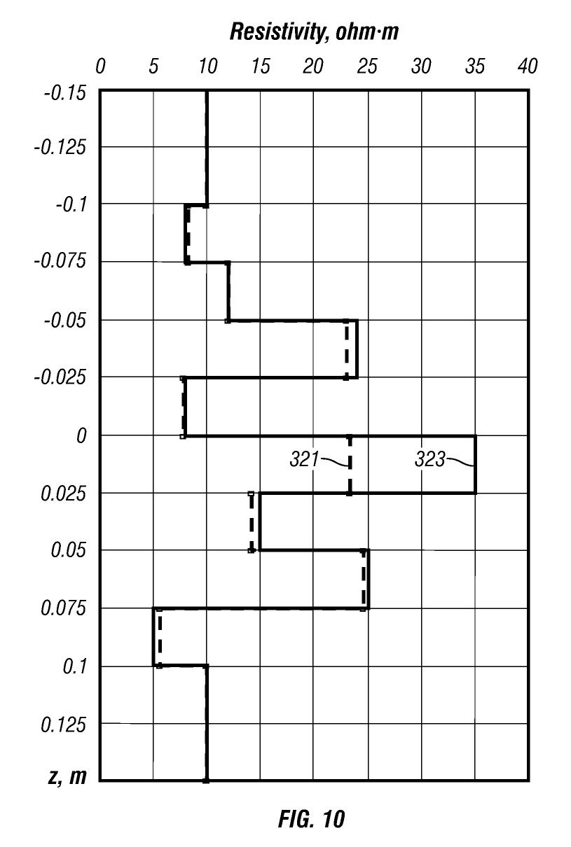

FIG. 10 shows the results of the inversion of the logs of FIGS. 9A, 9B after one iteration 321 and after four iterations 323. At four iterations, the results had converged to very close to the true resistivity (compare with the resistivity values in FIG. 7). The iterative procedure is discussed below.

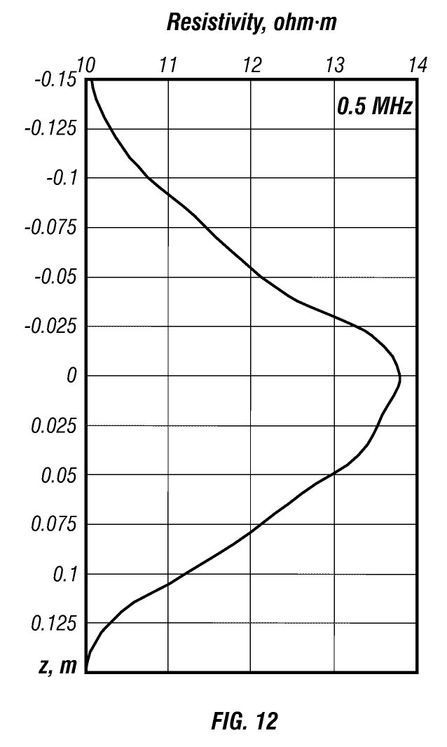

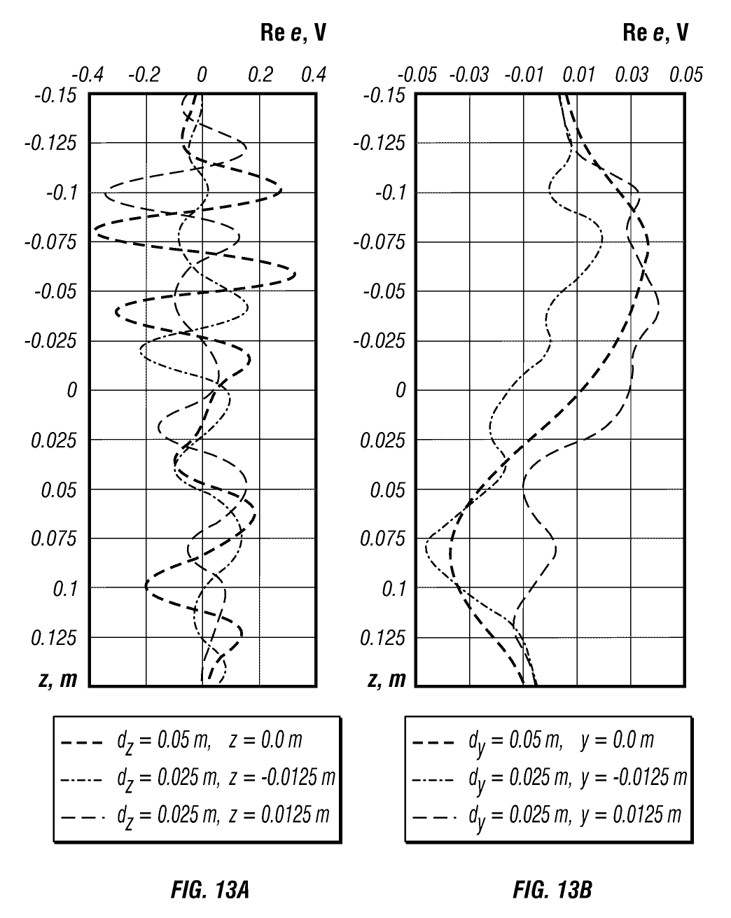

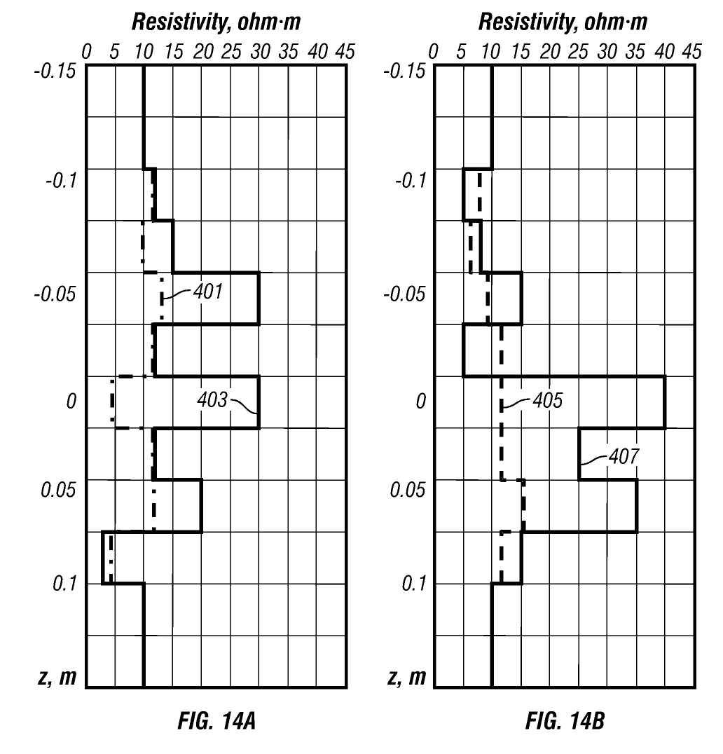

Next, a three-dimensional model based on the two-dimensional model is considered. In the 3-D model, at y=0, both 2D and 3D distributions are the same. The 3D resistivity distribution is shown in FIG. 11. Shown in FIG. 12 are the average 1D resistivity distribution obtained trough measurements by the differential array of the first type shown in FIG. 2. In FIG. 13A are shown synthetic logs for three arrays—the central array (203 and 207) (d_{z}=2r₀=0.05 m) and two symmetrical arrays (203 and 209; 207 and 209) (d_{z}=±r₀=±0.025 m). A measured signal ranges from −350 to 250 mV. At this we can see on the log the large number of extrema that arise at points where the system crosses layer boundaries. In FIG. 13B are shown logs for arrays with loop centers are located along the y axis as the array moves along the z axis. In this case a signal becomes essentially less than that in FIG. 13A and it ranges from −50 to 40 mV. The number of extrema decreases also (especially for the log obtained by the central array). Solution of the inverse problem results in reconstruction of the 3D distribution nearly without distortions. This is shown in FIGS. 14A and 14B.

Shown in FIG. 14A are inversion results for y≦0.05 m after one iteration 401 and after four iterations 403. FIG. 14B shows the inversion results for y≧0.05 m after one iteration 405 and after four iterations 407. The results are in good agreement with the model in FIG. 11.

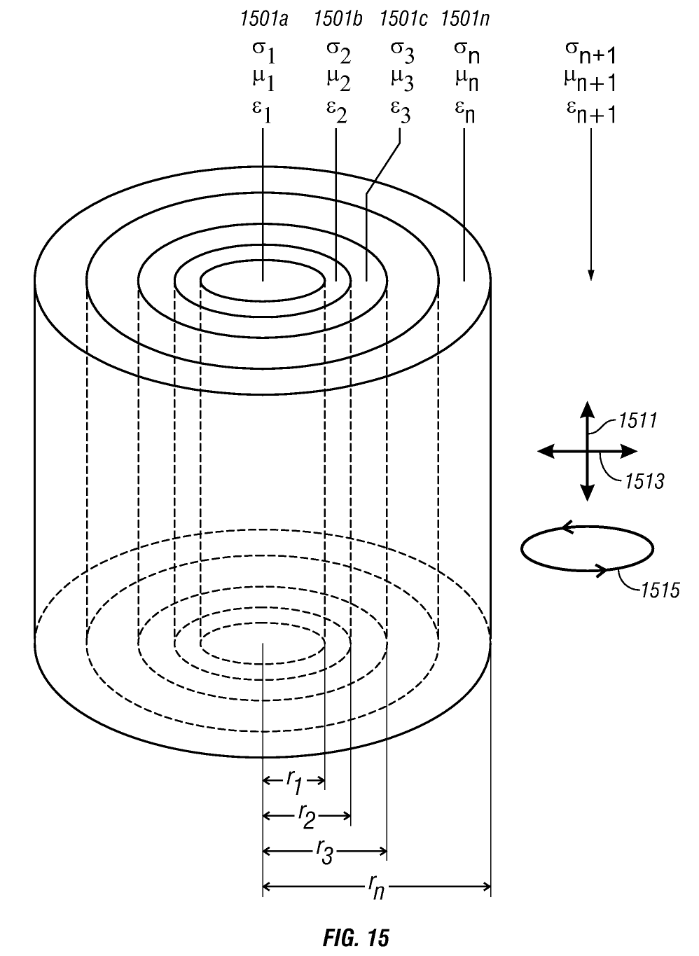

The response for the case of cylindrical layered geometry is now discussed. This disclosure represents the case when there is a logging tool, the borehole, a mudcake in the borehole, and invaded zone, an intermediate zone, and the virgin formation. A model for use is illustrated in FIG. 15. The medium consists of (N+1) coaxial inhomogeneous layers. The radius of boundary between n^{th} and n+1^{th} layers is equal to r=rₙ, (n=1, . . . ,N). The following notations are used herein:
r₁, r₂, . . . , r_{N}—radii of boundaries between layers;
\tilde{σ}₁, \tilde{σ}₂, . . . , \tilde{σ}_{N+1}—integrated electrical conductivities of layers;
μ₁, μ₂, . . . , μ_{N+1}—magnetic permeability of layers;
ε₁, ε₂, . . . , ε_{N+1}—layer permittivity.
   Hereinafter \tilde{σ}ₙ=σₙ−iωεₙ, where σₙ is electrical conductivity of n-th layer, =\sqrt{−1} is the imaginary unit, ω is the circular frequency.

The electrical resistivity of an anisotropic layer is described by the diagonal tensor

$$\hat{σ} = ( \begin{matrix}{σ}_{h} & 0 & 0 \\ 0 & {σ}_{h} & 0 \\ 0 & 0 & {σ}_{v}\end{matrix} ) ,$$

and that of isotropic one (σₕ=σᵥ) is described by the scalar. Three types of sources are considered. The first is a vertical magnetic dipole, the second is a horizontal magnetic dipole and the third is a current loop, shown in FIG. 15 by 1511, 1513 and 1515 respectively.

The case of a vertical magnetic dipole 1511 as the transmitter is considered first. The tangential electric field component in a homogenous medium is described by the following expression

$${E}_{ϕ} = i ω μ \frac{{M}_{z}}{2 {π}^{2}} {\int }_{0}^{∞} {pK}_{1} ( pr ) cos ( λ z ) d λ ,$$

where p=√λ²−iωμ\tilde{σ}, M_{z} is the dipole moment, z is the measurement point coordinate. It then follows from the second Maxwell equation that in n-th layer

$$\frac{1}{r} \frac{\partial ( {rE}_{ϕ} )}{\partial r} = i ω {μ}_{n} {H}_{z} .$$

Taking into account conditions on the axis and the descent principle, one can obtain

$${E}_{ϕ} = i ω {μ}_{n} \frac{{M}_{z}}{2 {π}^{2}} {\int }_{0}^{∞} {p}_{n}^{2} [ {D}_{n} {K}_{1} ( {p}_{n} r ) - {C}_{n} {I}_{1} ( {p}_{n} r ) ] cos ( λ z ) d λ , \\ {H}_{z} = - \frac{{M}_{z}}{2 {π}^{2}} {\int }_{0}^{∞} {p}_{n}^{2} [ {D}_{n} {K}_{1} ( {p}_{n} r ) - {C}_{n} {I}_{1} ( {p}_{n} r ) ] cos ( λ z ) d λ .$$

Here Cₙ, Dₙ are unknown coefficients. Note that D₁z≡1, C_{N+1}≡0. Here, Iₙ(.) and Kₙ(.) are the modified Bessel Functions of the first kind and the second kind of order n. The continuity conditions of components E_{φ} and H_{z} at the boundaries allow one to obtain 2N equations for the unknown coefficients. The system of equations is solved through recursion. To accomplish this, we introduce functions of both electric and magnetic types in each layer:

ζ^{e}(r)=pₙμₙ(DₙK₁(pₙr)+CₙI₁(pₙr)),

ζ^{h}(r)=pₙ²(DₙK₁(pₙr)−CₙI₁(pₙr)).

At the outer boundary of n-th layer

ζ^{e}(rₙ)=pₙμₙ(DₙK₁(pₙrₙ)+CₙI₁(pₙrₙ)),

ζ^{h}(rₙ)=pₙ²(DₙK₁(pₙrₙ)−CₙI₁(pₙrₙ)).

### Hence,

$${D}_{n} = {r}_{n} ( \frac{{I}_{0} ( {p}_{n} {r}_{n} )}{{μ}_{n}} {ζ}^{e} ( {r}_{n} ) + \frac{{I}_{1} ( {p}_{n} {r}_{n} )}{{p}_{n}} {ζ}^{h} ( {r}_{n} ) ) , \\ {C}_{n} = {r}_{n} ( \frac{{K}_{0} ( {p}_{n} {r}_{n} )}{{μ}_{n}} {ζ}^{e} ( {r}_{n} ) - \frac{{K}_{1} ( {p}_{n} {r}_{n} )}{{p}_{n}} {ζ}^{h } ( {r}_{n} ) ) .$$

In each layer, we obtain expressions for both functions through their values at the outer boundary:

$${ζ}^{e} ( r ) = {p}_{n} {μ}_{n} \{ \begin{matrix}\frac{{μ}_{n}}{{p}_{n}} [ {K}_{1} ( {p}_{n} r ) {I}_{1} ( {p}_{n} {r}_{n} ) - {K}_{1} ( {p}_{n} {r}_{n} ) {I}_{1} ( {p}_{n} r ) ] {ζ}^{h} ( {r}_{n} ) ++ \\ [ {K}_{1} ( {p}_{n} r ) {I}_{0} ( {p}_{n} {r}_{n} ) - {K}_{0} ( {p}_{n} {r}_{n} ) {I}_{1} ( {p}_{n} r ) ] {ζ}^{e} ( {r}_{n} )\end{matrix} \} , \\ {ζ}^{h} ( r ) = {p}_{n} {μ}_{n} \{ \begin{matrix}[ {K}_{0} ( {p}_{n} r ) {I}_{1} ( {p}_{n} {r}_{n} ) + {K}_{1} ( {p}_{n} {r}_{n} ) {I}_{0} ( {p}_{n} r ) ] {ζ}^{h} ( {r}_{n} ) ++ \\ \frac{{p}_{n}}{{μ}_{n}} [ {K}_{0} ( {p}_{n} r ) {I}_{0} ( {p}_{n} {r}_{n} ) - {K}_{0} ( {p}_{n} {r}_{n} ) {I}_{1} ( {p}_{n} r ) ] {ζ}^{e} ( {r}_{n} )\end{matrix} \} .$$

We find the C₁ coefficient from the continuity conditions at the first boundary:

$${C}_{1} = \frac{{p}_{1} {K}_{0} ( {p}_{1} {r}_{1} ) {ζ}^{e} ( {r}_{1} ) - {μ}_{1} {K}_{1} ( {p}_{1} {r}_{1} ) {ζ}^{h} ( {r}_{1} )}{{p}_{1} {I}_{0} ( {p}_{1} {r}_{1} ) {ζ}^{e} ( {r}_{1} ) + {μ}_{1} {I}_{1} ( {p}_{1} {r}_{1} ) {ζ}^{h} ( {r}_{1} )} . \qquad ( 27 )$$

The vertical magnetic field component H_{z} on the axis has the following form:

$${H}_{z} = \frac{{M}_{z}}{2 π {z}^{3}} ( 1 + {k}_{1} z ) {e}^{- {k}_{1} z} + \frac{{M}_{z}}{2 {π}^{2}} {\int }_{0}^{∞} {p}_{1}^{2} {C}_{1} cos ( λ z ) d λ , \\ where \\ {k}_{1} = \sqrt{- i ω {μ}_{1} {\tilde{σ}}_{1}} . \qquad ( 28 ) .$$

Thus, for a vertical magnetic dipole, a vertical component of the induced magnetic field is measured by the receiver antenna.

For the case of a horizontal magnetic dipole 1513 as the transmitter, vertical components of both the electric and magnetic field generated by horizontal magnetic dipole in homogenous medium have the form:

$${E}_{z} = i ω μ \frac{{M}_{r}}{2 {π}^{2}} sin ϕ {\int }_{0}^{∞} {pK}_{1} ( pr ) cos ( λ z ) d λ , \\ {H}_{z} = \frac{{M}_{r}}{2 {π}^{2}} cos ϕ {\int }_{0}^{∞} p λ {K}_{1} ( pr ) sin ( λ z ) d λ . \qquad ( 29 )$$

As it has been known, Fourier-transforms of horizontal components are expressed through Fourier-transforms of vertical components:

$${E}_{r}^{*} = \frac{1}{{p}_{hn}^{2}} ( λ \frac{\partial {E}_{z}^{*}}{\partial r} + \frac{i ω {μ}_{n}}{r} {H}_{z}^{*} ) , \\ {H}_{r}^{*} = - \frac{1}{{p}_{hn}^{2}} ( \frac{{σ}_{hn}}{r} {E}_{z}^{*} + λ \frac{\partial {H}_{z}^{*}}{\partial r} ) , \\ {E}_{ϕ}^{*} = \frac{1}{{p}_{hn}^{2}} ( \frac{λ}{r} {E}_{z}^{*} + i ω {μ}_{n} \frac{\partial {H}_{z}^{*}}{\partial r} ) , \\ {H}_{ϕ}^{*} = \frac{1}{{p}_{hn}^{2}} ( {σ}_{hn} \frac{\partial {E}_{z}^{*}}{\partial r} + \frac{λ}{r} {H}_{z}^{*} ) . \qquad ( 30 )$$

Let us set the problem for H*_{z} and E*_{z}.

$$\frac{1}{r} \frac{\partial }{\partial r} ( r \frac{\partial {E}_{z}^{*}}{\partial r} ) - \frac{1 + {p}_{vn}^{2} {r}^{2}}{{r}^{2}} {E}_{z}^{*} = 0 , \\ \frac{1}{r} \frac{\partial }{\partial r} ( r \frac{\partial {H}_{z}^{*}}{\partial r} ) - \frac{1 + {p}_{hn}^{2} {r}^{2}}{{r}^{2}} {H}_{z}^{*} = 0 , \\ Hereinafter$$

$${p}_{hn} = \sqrt{{λ}^{2} - i ω {μ}_{n} {σ}_{hn}} , \\ {p}_{vn} = \frac{{p}_{hn}}{Λ} = \sqrt{\frac{{λ}^{2}}{{Λ}^{2}} - i ω {μ}_{n} {σ}_{vn}} , \\ Λ = \sqrt{\frac{{σ}_{hn}}{{σ}_{vn}}} .$$

At r→0, it follows from eqn.(29) and eqn.(30) that
E*_{z}→iωμ₁p₁K₁(p₁r), H*_{z}→λp₁K₁(p₁r).
At r→0 |E*_{z}|→0, |H*_{z}|→0.
At r=rₙ tangential electromagnetic field components are continuous:

$${[ {E}_{z}^{*} ]}_{r = {r}_{n}} = 0 , \\ {[ {H}_{z}^{*} ]}_{r = {r}_{n}} = 0 , \\ [ \frac{1}{{p}_{hn}^{2}} ( {σ}_{hn} \frac{\partial {E}_{z}^{*}}{\partial r} + \frac{λ}{r} {H}_{z}^{*} ) ] {\vert}_{r = {r}_{n}} = 0 , \\ [ \frac{1}{{p}_{hn}^{2}} ( \frac{λ}{r} {E}_{z}^{*} + i ω {μ}_{n} \frac{\partial {H}_{z}^{*}}{\partial r} ) ] {\vert}_{r = {r}_{n}} = 0.$$

The solution for Fourier-transforms in n-th layer can be written in the form:

E*_{z}=AₙI₁(pₕₙr)+BₙK₁(pₕₙr),

H*_{z=C}ₙI₁(pₕₙr)+DₙK₁(pₕₙr).

Here Aₙ, Bₙ, Cₙ, Dₙ are unknown coefficients. In the inner layer, A_{N+1}=0 and C_{N+}1 =0. In the first layer, B₁=iωμ₁p₁ and D₁=λp₁.

We introduce vectors of functions that are continuous at interfaces and those of unknown coefficients for n-th layer:

$${\vec{Ψ}}_{n} = ( \begin{matrix}{E}_{z}^{*} \\ {H}_{z}^{*} \\ {f}_{n} \\ {g}_{n}\end{matrix} ) \qquad \vec{ψ} = ( \begin{matrix}{A}_{n} \\ {B}_{n} \\ {C}_{n} \\ {D}_{n}\end{matrix} ) ,$$

$$Here$$

$${f}_{n} = \frac{1}{{p}_{hn}^{2}} ( {σ}_{hn} \frac{\partial {E}_{z}^{*}}{\partial r} + \frac{λ}{r} {H}_{z}^{*} ) , \\ {g}_{n} = \frac{1}{{p}_{hn}^{2}} ( \frac{λ}{r} {E}_{z}^{*} + i ω {μ}_{n} \frac{\partial {H}_{z}^{*}}{\partial r} ) .$$

Then the boundary conditions can be written as:

$${\vec{Ψ}}_{n} = {\hat{Φ}}_{n} \cdot {\vec{ψ}}_{n} . \\ Here$$

$${\hat{Φ}}_{n} = ( \begin{matrix}{I}_{1} ( {p}_{hn} r ) & {K}_{1} ( {p}_{hn} r ) & 0 & 0 \\ 0 & 0 & {I}_{1} ( {p}_{hn} r ) & {K}_{1} ( {p}_{hn} r ) \\ \frac{{σ}_{hn}}{{p}_{hn}^{2}} {I}_{1}^{′} ( {p}_{hn} r ) & \frac{{σ}_{hn}}{{p}_{hn}^{2}} {K}_{1}^{′} ( {p}_{hn} r ) & \frac{λ}{{p}_{hn}^{2} r} {I}_{1} ( {p}_{hn} r ) & \frac{λ}{{p}_{hn}^{2} r} {K}_{1} ( {p}_{hn} r ) \\ \frac{λ}{{p}_{hn}^{2} r} {I}_{1} ( {p}_{hn} r ) & \frac{λ}{{p}_{hn}^{2} r} {K}_{1} ( {p}_{hn} r ) & \frac{i ω {μ}_{n}}{{p}_{hn}^{2}} {I}_{1}^{′} ( {p}_{hn} r ) & \frac{i ω {μ}_{n}}{{p}_{hn}^{2} r} {K}_{1} ( {p}_{hn} r )\end{matrix} ) .$$

On the assumption of continuity of tangential components at n-th boundary, we obtain:

\hat{Φ}ₙ₋₁(rₙ)·\vec{ψ}ₙ₋₁=\hat{Φ}ₙ(rₙ)·\vec{ψ}ₙ.

Thus, the relation between vectors of unknown coefficients \vec{ψ} in (n−1)-th and n-th layers can be established:

\vec{ψ}ₙ₋₁=\hat{Φ}ₙ₋₁⁻¹(rₙ)·\hat{Φ}ₙ(rₙ)·\vec{ψ}ₙ.

The inverse matrix \hat{Φ}ₙ⁻¹ has the form:

$$( \begin{matrix}{p}_{hn} {rK}_{0} ( {p}_{hn} r ) + {K}_{1} ( {p}_{hn} r ) & - λ / {σ}_{hn} {K}_{1} ( {p}_{hn} r ) & {p}_{hn}^{2} r / {σ}_{hn} {K}_{1} ( {p}_{hn} r ) & 0 \\ {p}_{hn} {rI}_{0} ( {p}_{hn} r ) - {I}_{1} ( {p}_{hn} r ) & λ / {σ}_{hn} {I}_{1} ( {p}_{hn} r ) & - {p}_{hn}^{2} r / {σ}_{hn} {I}_{1} ( {p}_{hn} r ) & 0 \\ - λ / ( i ω {μ}_{n} ) {K}_{1} ( {p}_{hn} r ) & {p}_{hn} {rK}_{0} ( {p}_{hn} r ) + {K}_{1} ( {p}_{hn} r ) & 0 & {p}_{hn}^{2} r / ( i ω {μ}_{n} ) {K}_{1} ( {p}_{hn} r ) \\ λ / ( i ω {μ}_{n} ) {I}_{1} ( {p}_{hn} r ) & {p}_{hn} {rI}_{0} ( {p}_{hn} r ) - {I}_{1} ( {p}_{hn} r ) & 0 & - {p}_{hn}^{2} r / ( i {ωμ}_{n} ) {I}_{1} ( {p}_{hn} r )\end{matrix} ) \\ Hence , \\ {\vec{ψ}}_{1} = {\hat{Φ}}_{1}^{- 1} ( {r}_{1} ) \cdot {\hat{Φ}}_{2} ( {r}_{1} ) \cdot {\hat{Φ}}_{2}^{- 1} ( {r}_{2} ) \cdot {\hat{Φ}}_{3} ( {r}_{2} ) \cdot … \cdot {\hat{Φ}}_{N}^{- 1} ( {r}_{N} ) \cdot {\hat{Φ}}_{N + 1} ( {r}_{N} ) \cdot {\vec{ψ}}_{N + 1} . \qquad ( 31 )$$

Unknown coefficients for Fourier-transforms of vertical components can be determined from a system of linear equations (31). It is to be noted that \vec{ψ}₁ and \vec{ψ}_{N+1} contain two unknown coefficients each. The system of linear equations (31) is written as:

$$( \begin{matrix}{c}_{11} & {c}_{12} & {c}_{13} & {c}_{14} \\ {c}_{21} & {c}_{22} & {c}_{23} & {c}_{24} \\ {c}_{31} & {c}_{32} & {c}_{33} & {c}_{34} \\ {c}_{41} & {c}_{42} & {c}_{43} & {c}_{44}\end{matrix} ) ( \begin{matrix}0 \\ {B}_{N + 1} \\ 0 \\ {D}_{N + 1}\end{matrix} ) = ( \begin{matrix}{A}_{1} \\ {B}_{1} \\ {C}_{1} \\ {D}_{1}\end{matrix} ) .$$

It is solved as follows:

$${A}_{1} = \frac{( {c}_{14} {c}_{22} - {c}_{12} {c}_{24} ) {D}_{1} + ( {c}_{12} {c}_{44} - {c}_{14} {c}_{42} ) {B}_{1}}{{c}_{44} {c}_{22} - {c}_{42} {c}_{24}} , \\ {C}_{1} = \frac{( {c}_{34} {c}_{22} - {c}_{32} {c}_{24} ) {D}_{1} + ( {c}_{32} {c}_{44} - {c}_{34} {c}_{42} ) {B}_{1}}{{c}_{44} {c}_{22} - {c}_{42} {c}_{24}} .$$

We already know coefficients B₁ and D₁. Hence, an expression for the magnetic field at the borehole can be obtained. Thus the horizontal component of a magnetic field Hₓ has the following form:

$${H}_{x} = - \frac{{M}_{x}}{4 π {z}^{3}} ( 1 + {k}_{1} z + {k}_{1}^{2} {z}^{2} ) {e}^{- {k}_{1} z} - \frac{{M}_{x}}{4 {π}^{2}} {\int }_{0}^{∞} \frac{{\hat{σ}}_{1} {A}_{1} + λ {C}_{1}}{{p}_{1}} cos ( λ z ) d λ .$$

Thus, for a horizontal magnetic dipole source, the corresponding horizontal magnetic field is measured by the receiver antenna.

We next consider the case of a current loop 1515 as the transmitter. We introduce the cylindrical coordinate system {r,φ,z}. The z axis is in line with the symmetry axis of the model and it is directed downward. For a current loop, the coordinate origin is at its center (z₀=0).

Let us find expressions for the electromagnetic field generated by a current loop. In this case there is only one tangential component of exterior current

J_{φ}^{cm}(φ,z)=I·δ(z−z₀),

where I is the current strength, z₀ is the depth of current loop position, δ(z) is Dirac delta-function.

At simple boundaries (r=rₙ, n≠l, 1≦l≦N) between layers, tangential electric field components (H_{z}, H_{φ}, E_{z}, E_{φ}) are continuous. At the interface r=rₗ, where the loop is located, particular boundary conditions should be met. Then in the problem, a source is accounted for as additional condition at this interface:

[H_{φ}]ᵣ₌ᵣ_{ₗ}=J_{z}^{cm}(z), [E_{φ}]ᵣ₌ᵣ_{ₗ}=0,

[H_{z}]ᵣ₌ᵣ_{ₗ}=−J_{z}^{cm}(z), [E_{z}]ᵣ₌ᵣ_{ₗ}=0.

In the n-th layer, the components Eᵣ and Hᵣ obey equation:

$$Δ F - \frac{F}{{r}^{2}} - {k}_{n}^{2} F = 0 , \\ F ( r , z ) = {H}_{r} ( r , z ) , {E}_{r} ( r , z ) , \qquad ( 31 )$$

and boundary conditions:

$$\begin{matrix}{[ \tilde{σ} {E}_{r} ]}_{r = {r}_{n}} = \{ {\begin{matrix}- \frac{\partial {J}_{z}^{cm}}{\partial z} , & n = l , \\ 0 , & n \neq l ,\end{matrix} [ μ {H}_{r} ]}_{r = {r}_{n}} = 0 , & ( 32 ) \\ [ \frac{{E}_{r}}{r} + \frac{\partial {E}_{r}}{\partial r} ] {\vert}_{r = {r}_{n}} = 0 , \\ [ \frac{{H}_{r}}{r} + \frac{\partial {H}_{r}}{\partial r} ] {\vert}_{r = {r}_{n}} = \{ \begin{matrix}- \frac{\partial {J}_{ϕ}^{cm}}{\partial z} & n = l , \\ 0 , & n \neq l ,\end{matrix} , & ( 33 )\end{matrix}$$

Scalar problems defined by eqns.(31)-(33) for Eᵣ and Hᵣ are independent. For separation of variables, the Fourier transform over the z coordinate is used

$$f ( r , z ) = \frac{1}{2 π} {\int }_{- ∞}^{∞} {f}^{*} ( r , ξ ) \cdot {e}^{iξ z} d ξ , \\ {f}^{*} ( r , ξ ) = \frac{1}{2 π} {\int }_{- ∞}^{∞} f ( r , z ) \cdot {e}^{- iξ z} d z .$$

Applying the transform to the eqns. (31)-(33), we obtain:

$${E}_{r}^{*} ( r , ξ ) = X ( r ) {A}^{*} ( ξ ) , {H}_{r}^{*} ( r , ξ ) = Y ( r ) {B}^{*} ( ξ ) , \\ where$$

$${A}^{*} ( ξ ) = - {\int }_{- ∞}^{∞} \frac{\partial {J}_{z}^{cm}}{\partial z} {e}^{- iξ z} d z = 0 , \\ {B}^{*} ( ξ ) = - {\int }_{- ∞}^{∞} \frac{\partial {J}_{ϕ}^{cm}}{\partial z} {e}^{- iξ z} d z = iξ I {e}^{- iξ {z}_{0}} .$$

Thus we have reduced the problem to finding two functions X(r) [symbol] Y(r) that are independent of one another. Two boundary problems include the same equations

$$\frac{{\partial }^{2} F}{\partial {r}^{2}} + \frac{1}{r} \frac{\partial F}{\partial r} - ( \frac{1}{{r}^{2}} + {p}_{n}^{2} ) F = 0 , \\ F = X ( r ) , Y ( r ) ,$$

and different conditions at boundaries

$$for X : for Y : \\ {[ \tilde{σ} X ]}_{r = {r}_{n}} = \{ \begin{matrix}1 , & n = l \\ 0 , & n \neq l\end{matrix} , {[ μ Y ]}_{r = {r}_{n}} = 0 , \\ [ \frac{X}{r} + {X}_{r}^{′} ] {\vert}_{r = {r}_{n}} = 0 , [ \frac{Y}{r} + {Y}_{r}^{′} ] {\vert}_{r = {r}_{n}} = \{ \begin{matrix}1 , & n = l \\ 0 , & n \neq l\end{matrix} .$$

Here pₙ=\sqrt{ξ²−iωμₙ\tilde{σ}ₙ}, X and Y are finite at r=0 and tends to 0 at r→∞. Expressions for electromagnetic field components are as follows:

$$\begin{matrix}{H}_{r}^{*} = Y {B}^{*} , & {E}_{r}^{*} = X {A}^{*} , \\ {H}_{ϕ}^{*} = i {\tilde{σ}}_{n} {r}^{2} \overline{ξ} \cdot X \cdot {A}^{*} , & {E}_{ϕ}^{*} = - {ωμ}_{n} {r}^{2} \overline{ξ} \cdot Y \cdot {B}^{*} , \\ {H}_{z}^{*} = i r \overline{ξ} ( Y + r \frac{\partial Y}{\partial r} ) {B}^{*} , & {E}_{z}^{*} = i r \overline{ξ} ( X + r \frac{\partial x}{\partial r} ) {A}^{*} ,\end{matrix}$$

$$where \overline{ξ} = \frac{ξ}{{r}^{2}} .$$

We designate X(r) and Y(r) through R(r). The function R(r) can be defined as:

$$R ( r ) = \{ \begin{matrix}P ζ ( r ) , & r < {r}_{l} \\ Q ζ ( r ) , & r > {r}_{l}\end{matrix} .$$

We give expressions for the function ζ(r) trough its values

ζ_{j±0}=ζ(r)|ᵣ₌ᵣ_{ⱼ}_{±0}, ζ′_{j±0}=ζ′ᵣ(r)|ᵣ₌ᵣ_{ⱼ}_{±0} at the outer (j=n+1) and inner (j=n) boundaries of n-th layer. Through the values at the inner boundary, we have:

$$ζ ( r ) = \frac{{ζ}_{1 - 0}}{{I}_{1} ( {p}_{0} {r}_{1} )} {I}_{1} ( {p}_{0} r ) , r < {r}_{i} , \\ ζ ( r ) = {r}_{n + 1} ⌊ {ζ}_{n + 1 - 0} {α}_{1}^{1} ( r , n ) - {ζ}_{n + 1 - 0}^{′} {β}_{1}^{1} ( r , n ) ⌋ .$$

Through the values at the outer boundary, we have:

$$ζ ( r ) = {r}_{n} [ {ζ}_{n + 0} {α}_{1}^{0} ( r , n ) - {ζ}_{n + 0}^{′} {β}_{1}^{0} ( r , n ) ] , \\ ζ ( r ) = \frac{{ζ}_{N + 0}}{{K}_{1} ( {p}_{N} {r}_{N} )} {K}_{1} ( {p}_{N} r ) , r > {r}_{N} . \\ Here$$

$${α}_{m}^{j} ( r , n ) = {I}_{m , r}^{′} {\vert}_{r = {r}_{n + j}} {K}_{m} ( {p}_{n} r ) - {K}_{m , r}^{′} {\vert}_{r = {r}_{n + j}} {I}_{m} ( {p}_{n} r ) , \\ {β}_{m}^{j} ( r , n ) = {I}_{m} ( {p}_{n} {r}_{n + j} ) {K}_{m} ( {p}_{n} r ) - {K}_{m} ( {p}_{n} {r}_{n + j} ) {I}_{m} ( {p}_{n} r ) , \\ {I}_{m , r}^{′} {\vert}_{r = {r}_{n}} = \frac{\partial {I}_{m} ( {p}_{n} r )}{\partial r} {\vert}_{r = {r}_{n}} , {K}_{m , r}^{′} {\vert}_{r = {r}_{n}} = \frac{\partial {K}_{m} ( {p}_{n} r )}{\partial r} {\vert}_{r = {r}_{n}} .$$

At the boundary (r=rₙ, n≠l), the following functions are continuous:

$$for X : {f}_{x} = \frac{ζ}{r} + {ζ}_{r}^{′} , {h}_{x} = \hat{σ} ζ , \\ for Y : {f}_{y} = μζ , {h}_{y} = \frac{ζ}{r} + {ζ}_{r}^{′} .$$

Constants P and Q are determined from conditions at the boundary where a loop is located.

Finally we obtain:

$$R ( r ) = \frac{f {\vert}_{r = {r}_{l} + 0}}{f {\vert}_{r = {r}_{l} - 0} \cdot h {\vert}_{r = {r}_{l} + 0} - f {\vert}_{r = {r}_{l} + 0} \cdot h {\vert}_{r = {r}_{l} - 0}} ζ ( r ) , r < {r}_{l} , \\ R ( r ) = \frac{f {\vert}_{r = {r}_{l} - 0}}{f {\vert}_{r = {r}_{l} - 0} \cdot h {\vert}_{r = {r}_{l} + 0} - f {\vert}_{r = {r}_{l} + 0} \cdot h {\vert}_{r = {r}_{l} - 0}} ζ ( r ) , r > {r}_{l} .$$

The values of functions X(r) and Y(r) can be determined going successively from one boundary to another that allows one to find Fourier-transforms of all magnetic field components. Note that the inversion procedure is based on measurements of Hᵣ, H_{φ} and H_{z} (or Eᵣ, E_{φ} and E_{z}).

To summarize, solutions to the forward problem have been given for several modeling assumptions. One model discussed was a 2-D model in which the formation was modeled by substantially planar layers with no change in the properties in the y-direction. Another model discussed was a 3-D model in which the formation was modeled by substantially planar layers and there is a change in the properties of the layers in the y-direction. These two models were also discussed in U.S. Pat. No. 7,299,131 to Tabarovsky et al. Methods of modeling the situation for cylindrical layering have been discussed in the present document.

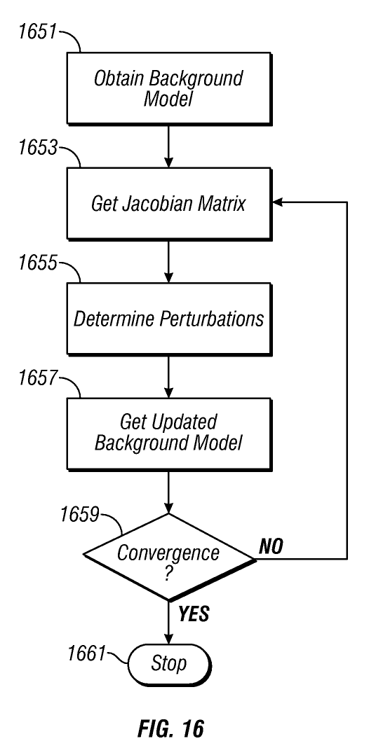

A brief explanation of the iterative procedure follows. Referring to FIG. 16, as noted above, an initial model 1651 is the starting point for the inversion. Using the Jacobian matrix A discussed above 1653, perturbations to the conductivity model are obtained 1655 using eq. (26). Specifically, the difference between the measurements and the model output are inverted using the Jacobian matrix. This perturbation is added 1657 to the initial model and, after optional smoothing, a new model is obtained. A check for convergence between the output of the new model and the measurements is made 1659 and if a convergence condition is met, the inversion stops 1661. If the convergence condition is not satisfied, the linearization is then repeated 1653 with the new Jacobian matrix. The convergence condition may be a specified number of iterations or may be the norm of the perturbation becoming less than a threshold value.

An aspect of the inversion procedure is the definition of the initial model. The initial model comprises two parts: a spatial configuration of the borehole wall and a background conductivity model that includes the borehole and the earth formation. In one embodiment of the disclosure, caliper measurements are made with an acoustic or a mechanical caliper. An acoustic caliper is discussed in U.S. Pat. No. 5,737,277 to Priest having the same assignee as the present disclosure and the contents of which are fully incorporated herein by reference. Mechanical calipers are well known in the art. U.S. Pat. No. 6,560,889 to Lechen having the same assignee as the present application teaches and claims the use of magnetoresistive sensors to determine the position of caliper arms.

The caliper measurements defines the spatial geometry of the model. The spatial geometry of the model is not updated during the inversion The borehole mud resistivity is used as an input parameter in the model. The mud resistivity can be determined by taking a mud sample at the surface. Alternatively, the resistivity of the mud may be made using a suitable device downhole. U.S. Pat. No. 6,801,039 to Fabris et al. having the same assignee as the present disclosure and the contents of which are incorporated herein by reference teaches the use of defocused measurements for the determination of mud resistivity. If surface measurements of mud resistivity are made, then Corrections for downhole factors such as temperature can be made to the measured mud resistivity by using formulas known in the art.

The disclosure has been described above with reference to a device that is conveyed on a drilling tubular into the borehole, and measurements are made during drilling The processing of the data may be done downhole using a downhole processor at a suitable location. It is also possible to store at least a part of the data downhole in a suitable memory device, in a compressed form if necessary. Upon subsequent retrieval of the memory device during tripping of the drillstring, the data may then be retrieved from the memory device and processed uphole. Due to the inductive nature of the method and apparatus, the disclosure can be used with both oil based muds (OBM) and with water based muds (WBM). The disclosure may also be practiced as a wireline implementation using measurements made by a suitable logging tool.

The processing of the data may be done by a downhole processor to give corrected measurements substantially in real time. Alternatively, the measurements could be recorded downhole, retrieved when the drillstring is tripped, and processed using a surface processor. Implicit in the control and processing of the data is the use of a computer program on a suitable machine readable medium that enables the processor to perform the control and processing. The machine readable medium may include ROMs, EPROMs, EEPROMs, Flash Memories and Optical disks.

While the foregoing disclosure is directed to the preferred embodiments of the disclosure, various modifications will be apparent to those skilled in the art. It is intended that all variations within the scope and spirit of the appended claims be embraced by the foregoing disclosure.

The scope of the disclosure may be better understood with reference to the following definitions:
caliper: A device for measuring the internal diameter of a casing, tubing or open borehole
coil: one or more turns, possibly circular or cylindrical, of a current-carrying conductor capable of producing a magnetic field;
EAROM: electrically alterable ROM;
EEPROM: EEPROM is a special type of PROM that can be erased by exposing it to an electrical charge.
EPROM: erasable programmable ROM;
flash memory: a nonvolatile memory that is rewritable;
induction: the induction of an electromotive force in a circuit by varying the magnetic flux linked with the circuit.
Initial model: an initial mathematical characterization of properties of a region of the earth formation consisting of two two parts: a spatial configuration of the borehole wall and a smooth background conductivity model that includes the borehole and the earth formation.;
Inversion: Deriving from field data a model to describe the subsurface that is consistent with the data
machine readable medium: something on which information may be stored in a form that can be understood by a computer or a processor;
Optical disk: a disc shaped medium in which optical methods are used for storing and retrieving information;
Resistivity: electrical resistance of a conductor of unit cross-sectional area and unit length; determination of resistivity is equivalent to determination of its reciprocal, conductivity;
ROM: Read-only memory.
Slickline A thin nonelectric cable used for selective placement and retrieval of wellbore hardware
vertical resistivity: resistivity in a direction parallel to an axis of anisotropy, usually in a direction normal to a bedding plane of an earth formation;
wireline: a multistrand cable used in making measurements in a borehole;

What is claimed is:

1. An apparatus for determining a conductivity of an earth formation, the apparatus comprising:
at least one transmitter antenna and at least one receiver coil disposed on a tool configured to be conveyed in a borehole in the earth formation, the at least one receiver configured to produce measurements indicative of the conductivity in response to activation of the at least one transmitter antenna; and
at least one processor configured to use an initial model to invert the measurements to give a conductivity model of the formation comprising a plurality of coaxial cylinders.

2. The apparatus of claim 1 wherein the at least one transmitter antenna comprises a vertical magnetic dipole and the at least one receiver coil is further configured to be responsive to a vertical component of a magnetic field produced by the at least one transmitter antenna.

3. The apparatus of claim 1 wherein the at least one transmitter comprises a horizontal magnetic dipole and the at least one receiver coil is configured to be responsive to a horizontal component of a magnetic field produced by the at least one transmitter antenna.

4. The apparatus of claim 1 wherein the at least one transmitter comprises a loop carrying a current and the at least one receiver coil is configured to be responsive to at least one of: (i) a vertical component of a magnetic field produced by the at least one transmitter antenna, (ii) a radial component of a magnetic field produced by the at least one transmitter antenna, (iii) an azimuthal component of a magnetic field produced by the at least one transmitter antenna, (iv) a vertical component of an electric field produced by the at least one transmitter antenna, (v) a radial component of an electric field produced by the at least one transmitter antenna, and (vi) an azimuthal component of an electric field produced by the at least one transmitter antenna.

5. The apparatus of claim 1 further comprising a caliper configured to provide an additional measurement indicative of a distance of the tool from a wall of the borehole and wherein the at least one processor is further configured to use the additional measurement to define the initial model.

6. The apparatus of claim 1 wherein the initial model further comprises: (i) a background resistivity of the formation, and (ii) a resistivity of a fluid in the borehole.

7. The apparatus of claim 1 further comprising:
a first resistivity measuring device configured to produce an output indicative of a background resistivity and substantially insensitive to a change in the wall of the borehole, and
a second resistivity measuring device configured to produce an output indicative of the resistivity of the fluid.

8. The apparatus of claim 1 wherein the at least one processor is further configured to invert the measurements by:
determining a difference between the measurements and an output of the initial model; and
obtaining an updated model by adding a perturbation determined from the difference to the initial model.

9. The apparatus of claim 6 wherein the at least one processor is further configured to determine the perturbation by using a Jacobian matrix determined from the initial model.

10. The apparatus of claim 1 further comprising a conveyance device configured to convey the logging tool into the borehole, the conveyance device selected from (i) a wireline, (ii) a drilling tubular, and (iii) a slickline.

11. A method of determining a conductivity of an earth formation, the method comprising:
using at least one transmitter antenna on a tool conveyed in a borehole to induce an electromagnetic field in the earth formation;
using at least one receiver coil on the tool to produce measurements indicative of a conductivity of the earth formation in response to activation of the at least one transmitter antenna; and
using an initial model to invert the measurements to provide a conductivity model of the earth formation comprising a plurality of coaxial cylinders.

12. The method of claim 11 wherein using the at least one transmitter antenna comprises using a vertical magnetic dipole and using the at least one receiver coil comprises using a coil that is responsive to a vertical component of a magnetic field produced by the at least one transmitter antenna.

13. The method of claim 11 wherein using the at least one transmitter antenna comprises using a horizontal magnetic dipole and using the at least one receiver comprises using a coil that is responsive to a horizontal component of a magnetic field produced by the at least one transmitter antenna.

14. The method of claim 1 wherein using the at least one transmitter antenna comprises using a loop carrying a current and using the at least one receiver coil comprises using a coil that is responsive to at least one of: (i) a vertical component of a magnetic field produced by the at least one transmitter antenna, (ii) a radial component of a magnetic field produced by the at least one transmitter antenna, (iii) an azimuthal component of a magnetic field produced by the at least one transmitter antenna, (iv) a vertical component of an electric field produced by the at least one transmitter antenna, (v) a radial component of an electric field produced by the at least one transmitter antenna, and (vi) an azimuthal component of an electric field produced by the at least one transmitter antenna.

15. The method of claim 11 further comprising using a measurement indicative of a distance of the tool from a wall of the borehole to define the initial model.

16. The method of claim 11 wherein inverting the measurements comprises:
estimating a difference between the measurements and an output of the initial model; and
obtaining an updated model by adding a perturbation determined from the difference between the measurements and an output of the initial model to the initial model.

17. The method of claim 11 further comprising a conveying the tool into the borehole using a conveyance device selected from a group consisting of: (i) a wireline, (ii) a drilling tubular, and (iii) a slickline.

18. A computer-readable-medium accessible to at least one processor, the computer-readable medium comprising instructions that enable the at least one processor to use an initial model to invert measurements indicative of a conductivity of the earth formation made by an apparatus including at least one transmitter antenna and at least one receiver antenna to provide a conductivity model of the formation that comprises a plurality of coaxial cylinders.

19. The computer-readable-medium of claim 18 further comprising instructions that enable the at least one processor to use a measurement indicative of a distance of the at least one transmitter antenna from a wellbore wall to define the initial model.

20. The computer-readable-medium of claim 18 further comprising instructions that enable the at least one processor to:
determine a difference between the measurements and an output of the initial model; and
obtain an updated model by adding a perturbation determined from the difference to the initial model.
